(19) United States
(12) Patent Application Publication
(10) Pub. No.: US 2017/0112090 A1
(43) Pub. Date: Apr. 27, 2017

(54) ANIMAL LITTER HAVING IMPROVED ODOR CONTROL AND ABSORBENCY

(71) Applicant: GP Cellulose GmbH, Zug (CH)

(72) Inventors: Darold D. Tippey, Kennedale, TX (US); Anna L. Wells, Brunswick, GA (US); Ernest R. Fish, Lawrenceville, GA (US)

(73) Assignee: GP Cellulose GmbH, Zug (CH)

(21) Appl. No.: 15/317,387

(22) PCT Filed: Jun. 17, 2015
(86) PCT No.: PCT/US15/36149

§ 371 Date: Dec. 8, 2016

Related U.S. Application Data
(60) Provisional application No. 62/014,755, filed on Jun. 20, 2014.

(51) Int. Cl. A01K 1/015

(52) U.S. Cl. CPC A01K 1/0155; A01K 1/0154

(57) ABSTRACT

The present invention relates to animal litter and more particularly to cat litter, which comprises oxidized cellulose, including non-regenerated oxidized cellulose. The oxidized cellulose animal litters are lightweight, highly absorbent, compressible and have excellent odor control and antimicrobial properties.

The present invention relates to animal litter and more particularly to cat litter, which comprises oxidized cellulose. The cellulose for use in the present disclosure is chemically modified to include functional groups on the fiber that improve absorbency and that provide odor control, thereby improving the cat-litter odor without the need for masking fragrances or odor masking substance.

Given the growing number of domestic animals used as house pets, there is a need for litters so that animals may eliminate liquid or solid waste indoors in a controlled location. However, inevitably, waste build-up leads to malodor production. Animal litter odor is highly objectionable and is made even more so when the litter-box is located in a small or closed room. Many commercial litter products contain a fragrance that is intended to overpower or mask the litter smell. In these products, the scent producing ingredient is generally incorporated into the cat litter causing the scent to be released continuously creating an overpowering smell in a small or closed room. Overpowering scent is one reason people prefer unscented litter and strive to clean the litter box promptly when the litter box is used by the animal.

Litter compositions have been developed that clump when the litter box is used for urination thereby enabling prompt and easy cleaning of agglomerated clumps. When animal litter is not of a clumping variety, it is increasingly difficult to control the odor since the urine excreted is absorbed over a much larger distance.

Bentonite, which is largely composed of montmorillonite, is routinely used in animal litter as it tends to clump in the presence of moisture, allowing waste to be isolated and removed from the litter remaining in the box. Like traditional clay litters, bentonite litters provide some inherent odor control, due to the isolation and entrapment of urine and its ability to hold ammonium gas (NH4) produced from urine degradation. However, even with a clumping agent, the litter will progressively accumulate malodor.

The literature describes two general ways that litter odor has been addressed. First, there are any number of deodorizers and sprays that are applied to the litter during use to mask or eliminate cat litter smells. These products often provide only short-term smell improvement. Second, the litter may contain one or more adjuvants that address odor and/or microbial growth. Such adjuvants include, for example, deodorants, germicides, and/or fragrances. These adjuvants are generally included in small quantities, for example, 1 to 10% but must be dispersed throughout the litter to be effective.

There remains a need for an animal litter that (i) can actively neutralize animal urine such as to avoid the release of ammonia, (ii) can provide rapid and long-term odor reduction, and (iii) does not contain germicides or bactericides, and therefore, may be disposed of in septic and sewage systems without killing the beneficial bacteria in those systems.

Paper or recycled pulp has been found to be a suitable litter material, see for example Sokolowski et al, U.S. Pat. No. 4,619,862, and Fleischer et al, U.S. Pat. No. 4,621,011. Paper, particularly cellulose, has a number of advantages over litters made from clay or other particulate solids. Cellulose is environmentally friendly as it is biodegradable, compostable, and in some instances, flushable. Further, litter made from cellulose is lightweight, highly absorbent, produces low lint and should not be harmful to an animal in the event of ingestion. However, a need still exists for an animal litter that enjoys the benefits associated with the use of cellulose while minimizing the malodor associated with cat litter.

### DETAILED DESCRIPTION

The present disclosure describes an odor control animal litter comprising particles or pellets of an absorbent litter substrate comprising an oxidized cellulose material. In various embodiments, the animal litter of the invention may be made from 100% oxidized cellulose or oxidized cellulose that is admixed with one or more additional litter substrates or adjuvants.

The disclosure also describes a method for reducing or controlling animal litter odor, comprising including within the litter an oxidized cellulose, including non-regenerated cellulose, for example, kraft cellulose, wherein the oxidized cellulose according to the disclosure when contacted with urine, reduces the amount of atmospheric ammonia. In some embodiments the disclosure provides a method for controlling odor comprising inhibiting bacterial odor generation. In some embodiments, the disclosure provides a method for controlling odor comprising absorbing odorants, such as nitrogenous odorants, onto the oxidized cellulose.

As used herein, “animal litter” and “cat litter” are interchangeable except where specifically indicated as different or where one of ordinary skill in the art would understand them to be different.

As used herein, “fiber,” “kraft fiber” and “cellulose” are interchangeable except where specifically indicated as different or where of ordinary skill in the art would understand them to be different. While the invention may be described at points in relation to the use of a cellulose fiber, the cellulose can be, but need not be in fiber form.

As used herein, the term “odor” is understood to mean a smell or odor that is capable of interacting with olfactory receptors. Smells or odors can be inherent to chemical materials or may be the byproduct of an organism, such as a bacteria, that is capable of generating compounds that generate a smell or odor, for example a bacteria that produces urea.

Cellulose exists generally as a polymer chain comprising hundreds to tens of thousands of glucose units. The main sources of cellulose fiber are wood pulp and cotton. Cotton is expensive, while wood pulp is an abundant and cost effect source of cellulose. The cellulose used in the litters described herein may be derived from softwood, hardwood, and mixtures thereof. In some embodiments, the cellulose is derived from softwood, such as southern pine. In some embodiments, the cellulose is derived from hardwood, such as eucalyptus. In some embodiments, the cellulose is derived from a mixture of softwood and hardwood.

The most typical cellulose fiber is produced by a chemical kraft pulping method and provides an inexpensive source of cellulose fiber. Cellulose for use in the litter described can be chosen from one or more of mechanical pulp, thermomechanical pulp (TMP), chem ithermomechanical pulp (CTMP), chemical pulp, and recycled pulp. Further, the pulp may be subjected to one or more additional processing stages, including but not limited to oxygen delignification and bleaching. However, the cellulose need not be subjected to any of these additional processing stages.

The cellulose may be produced using any drying method, including but not limited air drying, which product may, for example, be baled; Yankee drying, which product may be rolled or baled; and flash drying which products may, for example, be baled, bagged, or placed in any other suitable container.

Cellulose may be oxidized to modify its functionality. Various methods of oxidizing cellulose are known. In cellulose oxidation, hydroxyl groups of the glycosides of the cellulose chains can be converted, for example, to carbonyl groups such as aldehyde groups, ketone groups or carboxylic acid groups. Depending on the oxidation method and conditions used, the type, degree, and location of the carbonyl modifications may vary. Oxidized cellulose that can be used in the instant disclosure can be oxidized by any art recognized method. The oxidation may be a standalone process or may be combined with other post pulping processes to which the cellulose is already subject, for example, delignification or bleaching.

According to one embodiment, oxidized fiber for use in the animal litter of the present disclosure has been subjected to an oxidation treatment, for example, a copper or iron catalyzed peroxide treatment in an acidic environment. The oxidation of these fibers causes a change in the fiber's chemical functionality. Specifically, the fiber has more aldehydic and carboxylic functionality than non-oxidized fiber. According to one embodiment, fiber that may be used in the animal litter of the invention and its method of manufacture are described in published International Application Nos. WO2010/138941, WO2013/106703, and WO2013/158384, which are incorporated by reference in their entirety. Because of the changes to the chemical nature of the fibers, these fibers are absorbent, compressible and have excellent odor control and antimicrobial properties.

Exemplary Method for Making Oxidized Cellulose Fiber

A semi-bleached or mostly bleached kraft pulp may be treated with an acid, iron and hydrogen peroxide. The fiber may be adjusted to a pH of from about 2 to about 5 (if not already in this range) with sulfuric, hydrochloric, acetic acid, or filtrate from the washer of an acidic bleach stage, such as a chlorine dioxide stage. Iron may be added in the form of Fe⁺², for example iron may be added as ferrous sulfate heptahydrate (FeSO₄.7H₂O). The ferrous sulfate may be dissolved in water at a concentration ranging from about 0.1 to about 48.5 g/L. The ferrous sulfate solution may be added at an application rate ranging from about 25 to about 200 ppm as Fe⁺² based on the dry weight of pulp. The ferrous sulfate solution may then be mixed thoroughly with the pH-adjusted pulp at a consistency of from about 1% to about 15% measured as dry pulp content of the total wet pulp mass. Hydrogen peroxide (H₂O₂) may then be added as a solution with a concentration of from about 1% to about 50% by weight of H₂O in water, at an amount of from about 0.1% to about 3% based on the dry weight of the pulp. The pulp at a pH of from about 2 to about 5 mixed with the ferrous sulfate and peroxide may be allowed to react for a time ranging from about 40 to about 80 minutes at a temperature of from about 60 to about 80° C. The degree of viscosity (or DP) reduction is dependent on the amount of peroxide consumed in the reaction, which is a function of the concentration and amount of peroxide and iron applied and the retention time and temperature.

The treatment may be accomplished in a typical five-stage bleach plant with the standard sequence of D0 E1 D1 E2 D2. With that scheme, no additional tanks, pumps, mixers, towers, or washers are required, however oxidation could be carried out in an additional tank or tower. The fourth or E2 stage may be used for the treatment. The fiber on the D1 stage washer may be adjusted to a pH of from about 2 to about 5, as needed by addition of acid or of filtrate from the D2 stage. A ferrous sulfate solution may be added to the pulp either (1) by spraying it on the D1 stage washer mat through the existing shower headers or a new header, (2) added through a spray mechanism at the repulper, or (3) added through an addition point before a mixer or pump for the fourth stage. The peroxide as a solution may be added following the ferrous sulfate at an addition point in a mixer or pump before the fourth stage tower. Steam may also be added as needed before the tower in a steam mixer. The pulp may then be reacted in the tower for an appropriate retention time. The chemically modified pulp may then be washed on the fourth stage washer in a normal fashion. Additional bleaching may be optionally accomplished following the treatment by the fifth or D2 stage operated in a normal fashion.

Fiber Properties

Odor control and absorbency are increased as the level of functionality on the cellulose is increased. Aldehyde content, carbonyl content, carboxy content and copper number are fiber characteristics that assist in defining cellulose appropriate for use in the animal litter of the instant disclosure.

Oxidized cellulose for use in producing animal litter can have an aldehyde content ranging from about 1.0 meq/100 g to about 12 meq/100 g. In some embodiments, the aldehyde ranges from about 3.0 meq/100 g to about 12 meq/100 g. In some embodiments, the aldehyde content is greater than about 2.0 meq/100 g, for example, greater than about 4.0 meq/100 g, for example, greater than about 6.0 meq/100 g. Aldehyde content is measured according to Econotech Services LTD, proprietary procedure ESM 055B.

In some embodiments, the oxidized cellulose has a copper number or at least 2. In some embodiments, the copper number is at least about 3.0. In some embodiments, the copper number is at least about 4.0. In some embodiments, the copper number ranges from about 2 to about 9. Copper Number is measured according to TAPPI T430-cm99.

In some embodiments, the oxidized cellulose has a carboxyl content ranging from about 2 meq/100 g to about 12 meq/100 g. In some embodiments, the carboxyl content ranges from about 3 meq/100 g to about 12 meq/100 g. In some embodiments, the carboxyl content is at least about 3 meq/100 g, for example, at least about 4 meq/100 g, for example, at least about 5 meq/100 g. Carboxyl content is measured according to TAPPI T237-cm98.

In some embodiments, the oxidized cellulose has a carbonyl content ranging from about 1.0 meq/100 g to about 14 meq/100 g. In some embodiments, the carbonyl content ranges from about 2.0 meq/100 g to about 14 meq/100 g. In some embodiments, the carbonyl content is greater than about 2.0 meq/100 g, for example, greater than about 3.0 meq/100 g, for example, greater than about 4.0 meq/100 g. Carbonyl content is calculated from Copper Number according to the formula:

carbonyl=(Cu. No.−0.07)/0.6,

from Biomacromolecules 2002, 3, 969-975.

In some embodiments, the oxidized cellulose has a viscosity ranging from about 3.0 mPa·s to about 10 mPa·s. In some embodiments, the viscosity ranges from about 3.0 mPa·s to about 8.0 mPa·s. In some embodiments, the viscosity ranges from about 3.0 mPa·s to about 7.0 mPa·s. In some embodiments, the viscosity ranges from about 3.0 mPa·s to about 6.0 mPa·s. In some embodiments, the viscosity is less than 10 mPa·s, less than 8 mPa·s, less than 7 mPa·s, less than 6 mPa·s, or less than 5.5 mPa·s. Intrinsic Viscosity is measured according to ASTM D1795 (2007). 0.5% Capillary CED Viscosity is measured according to TAPPI T230-om99.

In some embodiments, the cellulose may be a softwood fiber and the method of oxidation results in minimal reduction in fiber length during the oxidation/bleaching process.

“Fiber length” and “average fiber length” are used interchangeably when used to describe the property of a fiber and mean the length-weighted average fiber length. Therefore, for example, a fiber having an average fiber length of 2 mm should be understood to mean a fiber having a length-weighted average fiber length of 2 mm.

In some embodiments, when the cellulose is a softwood fiber, the cellulose fiber has an average fiber length, as measured in accordance with Test Protocol 12, described in the Example section below, that is about 2 mm or greater. In some embodiments, the average fiber length is no more than about 3.7 mm. In some embodiments, the average fiber length is at least about 2.2 mm, about 2.3 mm, about 2.4 mm, about 2.5 mm, about 2.6 mm, about 2.7 mm, about 2.8 mm, about 2.9 mm, about 3.0 mm, about 3.1 mm, about 3.2 mm, about 3.3 mm, about 3.4 mm, about 3.5 mm, about 3.6 mm, or about 3.7 mm. In some embodiments, the average fiber length ranges from about 2 mm to about 3.7 mm, or from about 2.2 mm to about 3.7 mm. 12. Fiber length and coarseness is determined on a Fiber Quality Analyzer™ from OPTEST, Hawkesbury, Ontario, according to the manufacturer's standard procedures.

The oxidized cellulose as described has an improved wicking ability. In one embodiment where the oxidized cellulose may be admixed with another absorbent substrate, this improved wicking makes the oxidized cellulose the initial receptacle for urine, ensuring that the anti-odor properties are fully realized.

Oxidized cellulose reduces atmospheric ammonia concentration more than a litter produced with standard paper or recycled paper. The oxidized cellulose reduces at least about 40% more atmospheric ammonia than standard paper litter, for example at least about 50% more, or about 60% more, or about 70% more, or about 75% more, or about 80% more, or about 90% more ammonia than standard paper litter.

In some embodiments, the oxidized cellulose absorbs from about 5 to about 10 ppm ammonia per gram of fiber. For instance, the oxidized cellulose may absorb from about 6 to about 10 ppm, or from about 7 to about 10 ppm, or from about 8 to about 10 ppm ammonia per gram of cellulose.

In some embodiments, oxidized cellulose for use in the described litter has an MEM Elution Cytotoxicity Test, ISO 10993-5, of less than 2 on a zero to four scale. For example the cytotoxicity may be less than about 1.5 or less than about 1.

It is known that oxidized cellulose, in particular cellulose comprising aldehyde and/or carboxylic acid groups, exhibits anti-viral and/or antimicrobial activity. See, e.g., Song et al., Novel antiviral activity of dialdehyde starch, Electronic J. Biotech., Vol. 12, No. 2, 2009; U.S. Pat. No. 7,019,191 to Looney et al. For instance, aldehyde groups in dialdehyde starch are known to provide antiviral activity, and oxidized cellulose and oxidized regenerated cellulose, for instance containing carboxylic acid groups, have frequently been used in wound care applications in part because of their bactericidal and hemostatic properties.

In one embodiment, the oxidized cellulose of the disclosure exhibits antimicrobial activity. The antimicrobial activity can be characterized by bacteriostatic activity and bacteriocidal activity. The oxidized cellulose will exhibit a bacteriostatic activity after 4 hours of at least 2.5, for example, at least 3.0, for example 3.5. The oxidized cellulose of the disclosure will exhibit a bactericidal activity at 4 hours of at least 1.5, for example, at least 2.0. The anti-bacterial properties of the fibers of the disclosure inhibit the growth of one or more common bacteria, including but not limited to Staphylococcus aureus, Escherichia coli, Pseudomonas aeruginosa, and Enterococcus faecalisi. In some embodiments, oxidized cellulose fiber exhibits antiviral activity.

Litter Products

Products according to the present disclosure are useful in animal litters, including but not limited to, cats, rabbits, ferrets or other pets that will instinctively, or through training, make use of a litter box.

The litter product comprises oxidized cellulose. The cellulose may be provided in any form that will be acceptable in an animal litter. Such forms includes pellets, particles, fibers, bundled fibers, ropes, knots or other art recognized forms. Methods for forming the described forms is understood by the skilled artisan. Such processes may include, but are not limited to creating fiber bundles, pelletizing, cleaving the fiber into small pieces, or cleaving a fiber sheet/board into small pieces or particles, for example, dots or dashes.

Litter products or the instant disclosure can also comprise other type of absorbent litter substrates and/or other adjuncts or additives.

A wide variety of materials can be used for additional absorbent litter substrates in the product of the instant disclosure. For example, porous clays are readily adaptable for use as the absorbent substrates needed for litters. Their ability to absorb or adsorb moisture makes them excellent candidates for litters. Suitable litters include Georgia white clay, bentonite, montmorillonite, fossilized plant materials, expanded perlites, zeolites, silicon dioxide, gypsum, and vegetative matter, such as alfalfa (e.g., U.S. Pat. No. 3,923,005) and other equivalent materials known to those skilled in the art. Unoxidized paper or processed, recycled pulp can also be suitable litter material, e.g., such as disclose in Sokolowski et al, U.S. Pat. No. 4,619,862, and Fleischer et al, U.S. Pat. No. 4,621,011.

The animal litter of the instant invention can also include adjuncts selected from dyes, fragrances, pigments, dedusting compounds or agents, such as water-soluble polymeric resins, e.g., polyvinyl alcohol, polyvinyl pyrrolidone, polyacrylic acid, and mixtures of such resins, and mixtures thereof.

Acidifying agents can be included to control pH. Most preferred are mineral acids, such as inorganic acids selected from sulfuric, nitric, hydrochloric, phosphoric, sulfamic acids and mixtures thereof. Organic acids, such as sulfonic acid, malonic acid, succinic acid, maleic acetic acid, lactic acid, adipic acid, tartaric acid, and citric acid, and mixtures thereof, may also be suitable. Mixtures of organic and inorganic acids may be appropriate. The animal litter of the instant disclosure may include any art recognized additives that do not interfere with the function of the oxidized cellulose material.

Bacteriostats and germicides such as quaternary ammonium compounds, pine oil (see Stanislowski et al., U.S. Pat. No. 5,016,568 and), iodophores (such as disclosed in Baldry et al., U.S. Pat. No. 5,109,805) and certain 3-isothiazolones (sold under the trademark KATHON®); and, chemical deodorants, such as sodium bicarbonate, may also be added.

In some embodiments, the fiber may be combined with at least one super absorbent polymer (SAP). In some embodiments, the SAP may by an odor reductant. Examples of SAP that can be used in accordance with the disclosure include, but are not limited to, Hysorb™ sold by the company BASF, Aqua Keep® sold by the company Sumitomo, and FAVOR®, sold by the company Evonik.

When adding additional absorbent substrates or adjuvants to the animal litter, any know method for incorporating the oxidized cellulose and the remaining litter ingredients is acceptable. Such methods include, but are not limited to, blending, admixing, incorporating, uniting, or bonding. In the event one wishes to bond the materials of the litter, the selection of a bonding agent would be readily apparent to the skilled artisan. Bonding agents may be used either to bond the cellulose into bundles or to bond the cellulose with other absorbents or adjuvants. Suitable bonding agents include, for example, wax.

As used herein, “about” is meant to account for variations due to experimental error. All measurements are understood to be modified by the word “about”, whether or not “about” is explicitly recited, unless specifically stated otherwise. Thus, for example, the statement “a fiber having a length of 2 mm” is understood to mean “a fiber having a length of about 2 mm.”

The details of one or more non-limiting embodiments of the invention are set forth in the examples below. Other embodiments of the invention should be apparent to those of ordinary skill in the art after consideration of the present disclosure.

### EXAMPLES

### Example 1

A Southern pine pulp was collected from the D1 stage of a OD(EO)D(EP)D sequence. The starting 0.5% Capillary CED viscosity was 14.9 mPa·s (DPw 2028). Either 1.0% or 2% hydrogen peroxide was added with 100 or 200 ppm of Fe+² respectively. Other treatment conditions were 10% consistency, 80° C., and 1 hour retention time. These fluff pulps were then slurried with deionized water, wetlaid on a screen to form a fiber mat, dewatered via roller press, and dried at 250° F. The dry sheets were defibrated and airformed into 4″×7″ airlaid pads weighing 8.5 grams (air dried) using a Kamas Laboratory Hammerm ill (Kamas Industries, Sweden). A single, complete coverage sheet of nonwoven coverstock was applied to one face of each pad and the samples were densified using a Carver hydraulic platen press applying a load of 145 psig.

These pads were placed in individual 1.6 L airtight plastic containers having a removable lid fitted with a check valve and sampling port of ¼″ ID Tygon® tubing. Before securing the lid of the container, an insult of 60 grams deionized water and 0.12 gram 50% NH4OH at room temperature was poured into a centered 1″ ID vertical tube on a delivery device capable of applying a 0.1 psi load across the entirety of the sample. Upon full absorption of the insult, the delivery device was removed from the sample, the lid, with sealed sampling port, was fitted to the container, and a countdown timer started. At the conclusion of 45 minutes, a headspace sample was taken from the sampling port with an ammonia-selective short-term gas detection tube and ACCURO® bellows pump, both available from Draeger Safety Inc., Pittsburgh, Pa. The data in Table 18 show that the oxidized fibers produced within the scope of this disclosure were able to reduce the amount of ammonia gas in the headspace, resulting in a structure that provides suppression of a volatile malodorous compound often cited as unpleasant in wetted incontinence products.

TABLE 1

| | 0.5% CED | Aldehyde | Air Laid | Ammonia |
|---|---|---|---|---|
| Insult- 60 g H₂0/ | Viscosity | Content | Pad | (ppm) @ |
| 0.12 g 50% NH₄OH | (mPa · s) | meq/100 g | Weight (g) | 45 mins |
| Standard Kraft | 14.9 | 0.23 | 9.16 | 210 |
| Southern Pine Fiber | | | | |
| Oxidized Kraft | 4.7 | 3.26 | 9.11 | 133 |
| Southern Pine Fiber- | | | | |
| 1.0% H₂O₂/100 ppm | | | | |
| Fe | | | | |
| Oxidized Kraft | 3.8 | 4.32 | 9.23 | 107 |
| Southern Pine Fiber- | | | | |
| 2.0% H₂O₂/200 ppm | | | | |
| Fe | | | | |

### Example 2

The E2 (EP) stage of an OD(EOP)D(EP)D sequence was altered to produce an oxidized cellulose. A solution of FeSO₄.7H₂O was sprayed on the pulp at the washer repulper of the D1 stage at an application rate of 100 ppm as Fe⁺². No caustic (NaOH) was added to the E2 stage and the peroxide application was increased to 1.4%. The retention time was approximately 1 hour and the temperature was 79° C. The pH was 2.9. The treated pulp was washed on a vacuum drum washer and subsequently treated in the final D2 stage with 0.7% ClO₂ for approximately 2 hours at 91° C. The 0.5% Capillary CED viscosity of the final bleached pulp was 6.5 mPa·s (DPw 1084) and the ISO brightness was 87.

Defibrated fibers were airformed into 4″×7″ pads weighing 4.25 grams (air-dried). Sodium polyacrylate superabsorbent (SAP) granules sourced from BASF were applied evenly between two 4.25 gram pads. A full coverage nonwoven coverstock was applied to the top face of the fiber/SAP matrix and the pad was densified by a load of 145 psig applied via Carver platen press.

Synthetic urine was prepared by dissolving 2% Urea, 0.9% Sodium Chloride, and 0.24% nutrient broth (Criterion™ brand available through Hardy Diagnostics, Santa Maria, Calif.) in deionized water, and adding an aliquot of Proteus Vulgaris resulting in a starting bacterial concentration of 1.4×10⁷CFU/ml. The pad described above was then placed in a headspace chamber as described in Example 1 and insulted with 80 ml of the synthetic urine solution. Immediately after insult, the chamber was sealed and placed in an environment with a temperature of 30° C. Drager sampling was performed in series at time intervals of four hours and seven hours. The experiment was repeated three times, and the average results are reported in Table 2.

TABLE 2

| | % | | | | % reduc- |
|---|---|---|---|---|---|
| | SAP | Ammonia | % reduction | Ammonia | tion |
| | add | (ppm) @ | over | (ppm) @ | over |
| | on | 4 hrs | control | 7 hrs | control |
| Oxidized Kraft | 23 | 2.5 | | 29 | |
| Southern | | | | | |
| Pine Fiber | | | | | |
| Control Kraft | 23 | 21.5 | 88 | 175 | 83 |
| Southern | | | | | |
| Pine Fiber | | | | | |
| Oxidized Kraft | 16.5 | 6.5 | | 123 | |
| Southern | | | | | |
| Pine Fiber | | | | | |
| Control Kraft | 16.5 | 36.5 | 82 | 550 | 78 |
| Southern | | | | | |
| Pine Fiber | | | | | |
| Oxidized Kraft | 0 | 70 | | 317 | |
| Southern | | | | | |
| Pine Fiber | | | | | |
| Control Kraft | 0 | 197.5 | 65 | 575 | 45 |
| Southern | | | | | |
| Pine Fiber | | | | | |

As can be seen from the data, atmospheric ammonia resulting from bacterial hydrolysis of urea is lower in composite structures incorporating oxidized cellulose.

### Example 3

The antimicrobial effectiveness of cellulose for use in the described litter was evaluated using two testing methods, the Halo Method and the Absorption Method. The Halo Method evaluates antibacterial activity by the existence of halos, or clear zone of inhibition. The Absorption Method evaluates antibacterial activity by the bacteriostatic activity value and the bactericidal activity value.

Test samples were prepared from fibers prepared in accordance with Example 1 of International publication WO2010/138941.

The halo test is applicable to those treatments that can diffuse into the agar medium. The halo test was carried out using an inoculum of Escherichia coli ATCC #25922 that was adjusted in nutrient broth to 106 Colony-Forming Units per milliliter (CFU/mL). One (1.0) mL of the adjusted inoculum was placed into sterile Petri dishes. Approximately 15 mL of nutrient agar was added to each dish and mixed well. After the plates had solidified, test samples were placed onto the center of the plate ensuring good contact with the inoculated agar. The plates were incubated for 48 hours at 35° C. After incubation, each plate was examined for a halo (zone of inhibition). The results are set for the below.

| | |
|---|---|
| Bacteria Concentration (cells/ml) | 4.3 × 10⁶ |
| Average Width of Halos (mm) | 0 mm - No Zone of Inhibition |
| Existence of Halos | Non-existent |

As can be seen from the results above, the biocidal activity in the cellulose is not based upon something that can migrate to the surrounding agar.

The samples were further tested by the absorption method. The absorption method evaluates antibacterial activity by the bacteriostatic activity value and the bactericidal activity value. The bacteriostatic activity value determines the ability of a sample to inhibit growth. The bactericidal activity value determines the samples ability to kill the bacteria.

The absorption method was carried out using inoculum of Escherichia coli ATCC #25922, which was adjusted with a spectrophotometer to a concentration of approximately 108 CFU/m L. Nutrient broth was used to further dilute the inoculum to 105 CFU/m L. The test samples and the standard control cloth were tested in triplicate at Times=0, 4, and 18 hours. Each test sample was placed in a sterile container and then inoculated with 0.2 mL of the inoculum. The samples were incubated for 4 and 18 hours at 35° C. At the appropriate contact time, 20.0 mL of ice-chilled saline was added to the container and shaken for 1 minute to facilitate the release of the inoculum from the sample surface into the saline solution. Serial dilutions of the saline solution containing the inoculum were plated. All plates were incubated at 35° C. for 24-48 hours. After incubation, bacterial colonies were counted and recorded. The results are set forth below.

| Bacterial Concentration | 1.5 × 10⁶ |
|---|---|
| Growth Value (4 hrs) | 1.9 |
| Growth Value (18 hrs) | 3.0 |

| | Bacteriostatic | Bactericidal |
|---|---|---|
| Sample (4 hours) | Activity | Activity |
| Oxidized Cellulose | 3.9 | 2.3 |
| Non-oxidized cellulose | 2.1 | −0.1 |

| | Bacteriostatic | Bactericidal |
|---|---|---|
| Sample (18 hours) | Activity | Activity |
| Oxidized Cellulose | 6.2 | 3.5 |
| Non-oxidized cellulose | 6.9 | 3.5 |

The bacteriostatic activity is the difference between the treated sample immediately after inoculation and treated sample after the contact time which is then subtracted from the growth rate.

The bactericidal activity value is the difference between the standard cloth immediately after inoculation and the sample after the contact time.

### Example 4

Kraft fiber is oxidized to an aldehyde content of greater than about 6.0 meq/100 g. The fiber is then processed into fiber bundles, pellets or particles and used as an animal litter having one or more of improved absorbency, odor control and antimicrobial activity.

### Example 5

Wood fiber is oxidized using an iron catalyst and hydrogen peroxide at an acidic pH. The oxidized cellulose is than processed into fiber bundles, pellets or particles and combined with an additional absorbent substrate and used as an animal litter having one or more of improved absorbency, odor control and antimicrobial activity.

We claim:

1. An animal litter comprising a oxidized cellulose.

2. The litter of claim 1, wherein the oxidized cellulose is pelletized.

3. The litter of claim 1, wherein the oxidized cellulose is flash dried.

4. The litter of claim 1, wherein the oxidized cellulose is cleaved into pieces.

5. The litter of claim 1, wherein the oxidized cellulose has an aldehyde content of from about 2 meq/100 g to about 12 meq/100 g.

6. The litter of claim 1, wherein the oxidized cellulose fiber has a carboxy content of from about 2 meq/100 g to about 12 meq/100 g.

7. The litter of claim 1, wherein the oxidized cellulose fiber has a copper number of at least about 3.

8. The litter of claim 1, wherein the oxidized cellulose fiber has a carbonyl content of from about 1.0 meq/100 g to about 14 meq/100 g.

9. The litter of claim 1, further comprising an additional absorbent substrate chosen from Georgia white clay, bentonite, montmorillonite, fossilized plant materials, expanded perlites, zeolites, silicon dioxide gypsum, and vegetative matter.

10. The litter of claim 1, further comprising an adjuvant chosen from one or more of a fragrance, a dye, a pigment, a dedusting compound, a germicide, a bacteriostat, a chemical deodorant, and an acidifying agent.

11. A method of making an animal litter or animal litter additive comprising, oxidizing cellulose to an aldehyde content of greater than about 6.0 meq/100 g;
converting the oxidized fiber to a pellet, particle or fiber bundle.

12. The method of claim 11, further comprising an additional absorbent substrate.

13. The method of claim 11, wherein the oxidized cellulose fiber and the additional absorbent substrate are admixed or bonded.

14. The method of claim 11, wherein an adjuvant is added to the animal litter.

15. The method of claim 1, wherein the oxidized cellulose is non-regenerated cellulose.
